(19) United States
(12) Patent Application Publication
(10) Pub. No.: US 2005/0019942 A1
(43) Pub. Date: Jan. 27, 2005

(54) Array-based biomolecule analysis

(75) Inventors: Andrew J. Sloane, Balmain (AU); Malcolm G. Pluskal, Acton, MA (US); Andrew A. Gooley, Pymble (AU); Janice Lee Joss, Erskineville (AU); Russell Ian Ludowyke, Willoughby (AU); Michael Kung-Hsi Hsu, Carlingford (AU)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Proteome Systems Ltd., North Ryde (AU)

(21) Appl. No.: 10/865,678

(22) Filed: Jun. 10, 2004

Related U.S. Application Data
(63) Continuation-in-part of application No. 10/471,355, filed on Jan. 9, 2004.

(30) Foreign Application Priority Data
Mar. 16, 2001 (AU) PR 3780

(51) Int. Cl. G01N 21/00; G01N 1/00

(52) U.S. Cl. 436/164; 436/86; 436/174

(57) ABSTRACT

Separation of macromolecules by one-dimensional or two-dimensional methods, such as gel electrophoresis, produces an array of macromolecules, which can be transferred to a support, thereby producing the same array as on the gel. In the case of one-dimensional gel electrophoresis, because of the regular spacing of the gel lanes and the predictable direction of migration of the macromolecules, the positions of the macromolecule spots or bands in the array can be predicted to be at least within the area of the support corresponding to the lanes of the gel. Where the molecular weight of a macromolecule of interest is known, molecular weight markers can be used to determine where the macromolecule band is on the support, even if the macromolecule is not stained in the gel or on the support. Assays that reveal characteristics of the macromolecule can be carried out by spotting reagents onto the support in a series of microspots of small volume in a line which intersects the macromolecule band, and which corresponds to the line of the direction of migration of the macromolecules on the gel. Appropriate detection methods can be applied, depending on the reagent, to see the results. The steps for locating the bands of macromolecules, applying reagents, and detecting the effect of the reagent on the macromolecule can be automated in an appropriate instrument.

### RELATED APPLICATIONS

This application is a continuation-in-part of U.S. application No. 10/471,355, filed Jan. 9, 2004 [35 U.S.C. §371(c) date], which is the U.S. National stage of International Application No. PCT/AU01/01562, filed 30 Nov. 2001, published in English. This application claims priority under 35 U.S.C. § 119 or 365 to Australia Application No. PR 3780, filed 16 Mar. 2001. The entire teachings of the above applications are incorporated herein by reference.

### FIELD OF THE INVENTION

This invention relates to the analysis of samples of biomolecules, particularly proteins.

### BACKGROUND OF THE INVENTION

There has been much discussion in recent literature on the development of a protein chip. Broadly, these are protein arrays (commonly called micro arrays). The current vision is for a protein micro array (in the meaning of the common usage) that will be able to measure thousands of proteins simultaneously, protein-protein interactions, small molecule interactions and enzyme substrate reactions.

Most current approaches to developing a protein chip rely on immobilising proteins on a substrate typically using surface chemistry to immobilise the proteins. The substrate for the chip may be a silicon wafer, but other material such as aluminium wafers and glass have been used or proposed for use as a substrate. After the substrate has been prepared it is necessary to attach a protein capture agent such as an antibody, to the chip. In one approach proposed by one California company, Zyomyx Inc., the substrate is coated with a thin organic film, an attachment tag is added to the top organic layer and a protein capture agent such as an antibody fragment or peptide is bound to the free end of the tag.

The current strategy is to have knowledge of what is being layered down on the chip surface, such as antibodies, or in some cases, known expressed proteins that are individually purified by affinity capture and then immobilised.

Other methods have been proposed for laying down antibodies. However, the task of laying down antibodies or other protein capture agents is far from straightforward. A further problem arises in that proteins are much less robust than DNA and are fragile and will denature if they are treated harshly. Proteins are also extremely sensitive to the physical and chemical properties of the particular substrate.

There are major drawbacks with existing protein chips. First, proteins have to be bonded to the chip in position in the array. As discussed above, this is typically done by using either arrayed antibodies, such as monoclonal antibodies, which are slow and expensive to produce, or using arrayed antigens. However, the specificity of the bound antigens and of the bound antibodies in particular, is not high.

A second problem is that the use of a single antibody cannot address the issue of a protein having a number of isoforms. It is possible that not all isoforms will be biologically active. There is a possibility that biologically active isoforms may be swamped by non-active isoforms.

There is a major problem with abundant proteins in a sample causing high background noise by non-specific binding to the array.

One solution, the use of recombinant antigens, does not produce authentic modifications, as the recombinant protein will almost certainly have different post translational modifications to the authentic protein. Thus, it impossible to be sure that the interaction on the protein chip is anything like a real interaction as would take place between an authentic protein and, for example, another protein.

The present invention seeks to address and alleviate the problems of the prior art as discussed above.

### SUMMARY OF THE INVENTION

In a first broad aspect, the present invention involves the step of generating an array of macromolecules and subsequently transferring the array of macromolecules to a support. This step generates a primary or macro array. One major advantage of this process is that authentic macromolecules can be arranged and immobilised without any chemistry for the immobilisation process as is required in the prior art protein chips.

The macro array of samples can be, for example, an array of macromolecules such as those isolated from a biological source (e.g., biomolecules such as proteins or nucleic acids). By macro array, it is meant that the samples are arranged in a pattern—regular or irregular, on a two-dimensional surface of a solid or in a semisolid or on a membrane support, which may be composed of a natural or synthetic polymer, for example.

The next step of the process of the present invention prints a secondary (or micro) array of reagents onto at least one coordinate of the captured primary array, typically by using image capture to define the coordinates. Apparatus which can be used to perform this function is described in U.S. Pat. No. 6,701,254, which describes an apparatus for capturing an image of an array of spots on a planar support and using that image to drive a print head of a chemical printer to a particular spot to apply a reagent to that spot. The chemical printer can dispense pico- to nanoliter volumes of fluids, using piezoelectric drop-on-demand ink-jet technology for precise and reproducible delivery of reagents. A battery of different tests can be performed on the same macrospot, or sample in the macro array.

The reagents to be applied onto a macrospot of sample, or onto a selected location of a blot or gel, can be applied in a regular pattern or micro array, for example a 2×2 or 3×3 square array of microspots. The reagents applied in the array can be the same or different for different microspots. In another embodiment, the microspots can be applied in a line across all or part of the macrospot. If the same reagent is applied in all the microspots, it is not necessary that the pattern of microspots, whether in a line or in a regular or irregular shape, be applied to a macrospot such that all the microspots are within the macrospot.

The term macromolecules covers any biomolecules selected from the group consisting of proteins, peptides, saccharides, lipids, nucleic acid molecules, complex biomolecules including glycoproteins, and mixtures thereof.

Proteins are ordinarily characterized as having a reported amino acid sequence, or if not characterized by amino acid sequence, by other physical and functional criteria, such as molecular weight, charge determined by isoelectric focusing, and enzymatic activity or binding activity. Peptides are ordinarily shorter than proteins, are usually without enzymatic function, and can be generated, for example, by enzymatic cleavage of proteins, or by synthesis from amino acids.

Isolated as used herein means separated from its original state, as it may occur in nature, and not necessarily purified to homogeneity. Protein extracts of cells, for example, provide isolated protein, and proteins further purified by separation from other proteins in a gel are also isolated proteins.

The biomolecules are preferably separated by chromatography to form an array of samples. The chromatography is preferably electrophoresis, and more preferably electrophoresis carried out in a polyacrylamide gel. Agarose or other suitable material can also be used as the separation medium.

The electrophoresis can be carried out in one dimension. Methods include, for example, isoelectric focusing, native polyacrylamide gel electrophoresis, and sodium dodecyl sulfate (SDS) polyacrylamide gel electrophoresis. Alternatively, the polyacrylamide gel electrophoresis is carried out in two dimensions with the first dimension by isoelectric focusing and the second dimension is by native polyacrylamide gel electrophoresis or SDS polyacrylamide gel electrophoresis. Other combinations of separation methods in the first and second dimensions can also be carried out. It is preferred to utilise a non-denaturing electrophoresis separation process whenever possible, as this generates a more authentic array of native, rather than de-natured proteins.

A preferred means of preparing the array for analysis is to transfer the proteins from the gel to a support. This technique is commonly referred to as “blotting” or “electroblotting.” The noncovalent interaction between the protein and the support is usually sufficient so that there is no need to use a chemical reaction to immobilize the protein to the support. However, the method does not preclude the use of a derivatised support where it may be an advantage to immobilise a specific class of biomolecule (e.g,. proteins that contain carbohydrate). The support can be, for example, a membrane made of polyvinylidene difluoride, nitrocellulose, nylon, Teflon™, Zitex™, polypropylene, polytetrafluroethylene (PTFE), and derivatised forms thereof having one or more functional groups.

The reagents that can be used in an assay include, for example, antibodies, enzymes, enzyme substrates, enzyme cofactors, ligands, stains, known reagents in protein chemistry and biological samples such as blood or urine or fractions of such samples. Multiple dilutions of reagent can be tested on a macrospot of macromolecule, for example, to titrate the binding of antibodies in an antibody-antigen reaction. Any of the reagents can be labelled for detection of binding to the macrospot, or for detection of a labelled reaction product, after separation from the reagent, e.g., by washing the support to which the macromolecules are bound, wherein the label can be, for example, a radioactive label, a fluorescent label, or biotin, for use with avidin or streptavidin. Where the reagent is an antibody, a secondary antibody used for detection can be Immunogold labelled, or can be conjugated to an enzyme that can produce a coloured or fluorescent product or a product detectable by infra-red.

Image analysis can determine the maximum number of spots that can be practically printed in the micro array as well as determining the individual spot-spot resolution for each molecule in the macro array.

The process of identifying an interaction that is specific or non-specific would follow methods in the public domain.

However, one could use a unique feature of the printing process where non-specific interactions are washed to an outer corona whereas specific interactions remain focused on the coordinate deposited. The existence or otherwise of specific interaction, is thus disclosed by the absence or presence of a corona.

Detection of the protein can be assisted by direct labelling with a marker or the like or use of a sandwich technique such as second antibody labelled fluorescence.

The next step in the process is the use of detection means to detect whether interactions have taken place between the protein spot and the reagent or reagents applied by the chemical printer. Detection may be carried out by any suitable means such as a global capture lens such as a CCD, camera, scanning or laser scanning, microscopy or the like.

In an alternative embodiment a detection means may be driven directly to each coordinate of the micro array.

It is envisaged that the process of the present invention could be used for batch mode purification of expressed proteins containing an affinity tag. For example, a batch of say 384 clones expressing a specific but different His-tag protein may be purified over an IMAC (immobilised metal affinity chromatography) column. The eluate from the column (i.e., all 384 clones) may then be arrayed using 2D electrophoresis and transferred to a substrate so as to generate a non-predetermined array. This is in direct contradiction to the existing teaching in the art, which relies on maintaining a pre-determined array and retaining positional information. One advantage of this example is that the arraying of the expressed proteins would provide a means of quality control of the expressed product compared to the predicted product (for example the predicted Mr and pI compared to the observed Mr and pI).

The principal advantage of the present invention over the prior art is that it generates an array of authentic proteins without the need for surface immobilisation chemistry as is required for existing protein chips. This is important in preserving post-translational modifications of proteins such as glycosylation and phosphorylation. By the methods described herein, antibodies specific to sites that have undergone post-translational modifications can be used to detect differences in phosphorylation that occur with cell differentiation, or in tumour cells compared to normal cells.

In one feature, the information contained in the image of the primary array can be used to define the type of micro array printed on the primary array. For example, the size of a particular spot to be analysed can be used to determine the pattern and spacing of reagents dispensed onto that spot. For example, an 8×8 array of reagents with 20 micron drops can be printed on a spot having a 200 microns diameter with the reagent spots spaced 25 microns apart, whereas with a larger, say 400 microns spot, the reagent spots may be spaced 50 microns apart. A typical protein spot distribution from a 2D gel can be 500-3000 microns. One model of chemical printer may generate an array of 100 micron droplets with 120 microns center to center. An experiment can be done using a 3×3 array of 100 micron micro-spots in a 500 micron 2D macrospot. A 10×10 array of 100 micron micro-spots easily fits inside a 2000 micron 2D spot.

Since there is sufficient accuracy in the depositing system it is possible to print very high density arrays onto individual positions of the primary array. With precision fibre optics it should be possible to identify minute interactions (e.g., a 10×10 array of 80 pL drops inside a 1000 micron spot).

In one particularly preferred feature, it would be an advantage to print multiple proteolytic enzymes as the micro array onto particular protein spots of the macro array. For example, on a 500 micron diameter protein spot a micro array of a number of endoproteinase enzymes (trypsin, endoproteinase LysC, endoproteinase GluC and endoproteinase Asp-N, with the preferred enzymes being trypsin and GluC), is printed in 200 micron size spots spaced 200 microns apart (centre to centre). The spot size and spacing is sufficiently small so that the average MALDI-TOF-MS nitrogen laser beam (100 micron) can be positioned so as to only desorb the analytes of one particular enzyme reaction within a spot of the macro array. The advantage of this feature is that the micro array of proteinases would lead to an increased peptide coverage detected during MALDI-TOF-MS analysis of the protein spot in the macro array.

### BRIEF DESCRIPTION OF THE DRAWINGS

Specific embodiments of the present invention will now be described, by way of example only, and with reference to the accompanying drawings.

FIG. 1 illustrates an array of proteins which have been separated by 2D electrophoresis and transferred onto a solid support membrane.

FIG. 2 illustrates a chemical printer being used to deposit a series of micro arrays of small spots on top of a protein spot identified in the array shown in FIG. 1.

FIG. 3 is a close up of the spot shown in FIG. 1 showing a micro array deposited onto that spot.

FIG. 4 is a schematic representation showing the process of obtaining information on an array of components or samples by way of acquiring or recording an image of the position of at least one component or sample in the array and utilising the recorded image so as to allow the manipulation of at least one component or sample in situ.

FIG. 5 is a schematic representation of equipment for imaging, manipulating and analysing at least one component or sample of an array of components or samples.

FIGS. 6A through 6C illustrate apparatus for clamping a nitrocellulose (NC) membrane.

FIGS. 7A and 7B illustrate the effect of microjetting TB negative or positive human serum onto a 38 kDa TB antigen.

FIGS. 8A and 8B illustrate the effect of micro-jetting Mycobacterium tuberculosis (TB) negative or positive human serum onto a denatured 38 kDa TB antigen with and without Direct Blue staining.

FIG. 9 shows a Membrane blot B745 adhered with double-sided tape to an AXIMA MALDI target plate.

FIG. 10 is a close-up of protein digested with trypsin and GluC endoproteases with matrix deposited on top.

FIG. 11 shows an X-ray film exposed to the membrane prepared in Example 4. FIG. 11 illustrates that differences in antibody binding, as seen in differences in staining, can be observed among the MHC samples, according to their phosphorylation. Antibody binding occurred only over the protein and not in the regions outside the protein band.

### DETAILED DESCRIPTION OF THE INVENTION

A description of preferred embodiments of the invention follows.

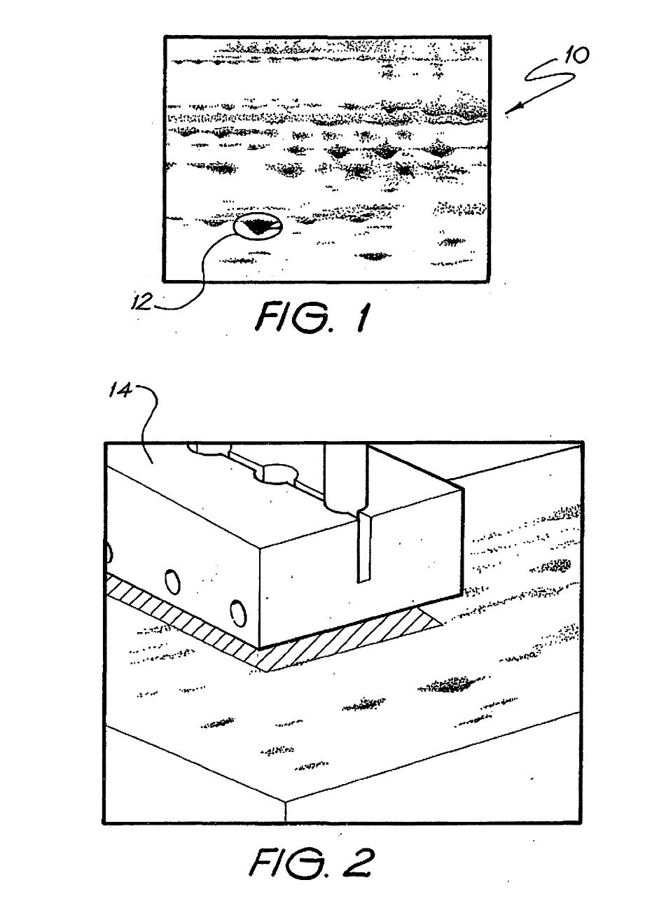

In the present invention, a mixture of proteins is fractionated to remove abundant proteins and a narrow range of pH gradient is used to resolve isoforms (1D electrophoresis). The fractionation process may be carried out using a multi compartment electrolyser such as is described in U.S. patent application Ser. No. 10/487,052, the entire contents of which are incorporated herein by reference. Instead of 1D electrophoresis, the sample, after removal of abundant proteins, may be separated out into an array [(10) illustrated in FIG. 1] using 2D electrophoresis or the like and the array is then transferred using electrophoretic blotting onto a membrane such as a nitrocellulose membrane. The array of proteins is now immobilised and ready to be treated as a “protein-chip.” It is to be noted that the array is not predetermined and it is not necessary at the time the array is generated to know which proteins are located in which position on the array.

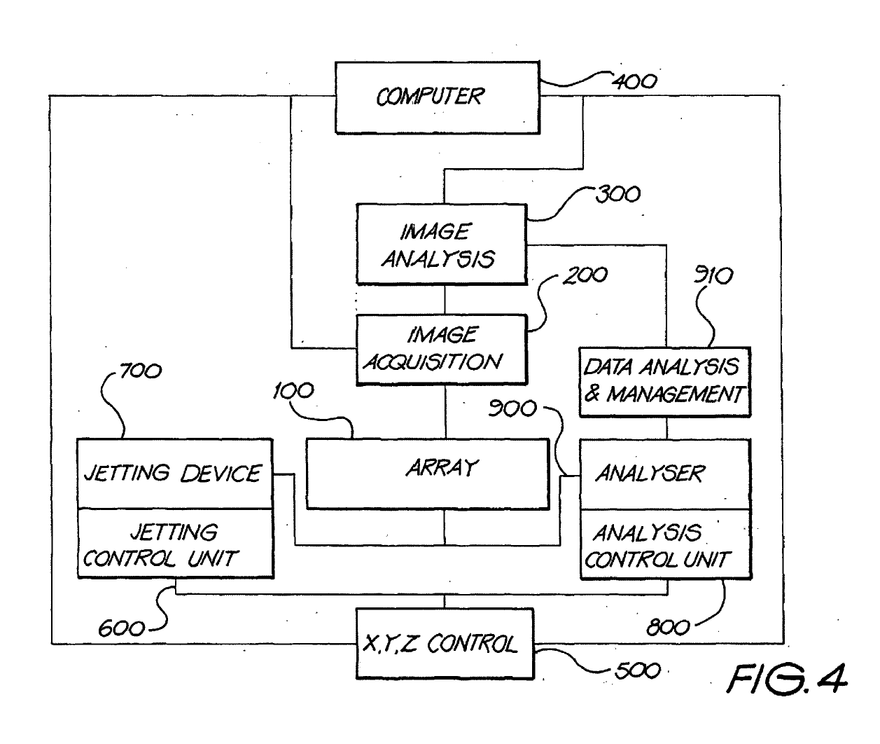

FIG. 1 illustrates a protein spot 12 which is ringed. The next step in the process is printing an array of reagents onto the protein spot. This is done by using the chemical printer described in U.S. Pat. No. 6,701,254 which is described below with reference to FIGS. 4 and 5.

FIG. 4 shows a schematic representation of an example of printer system function. The system comprises an array 100, an image acquisition system 200, an image analysis system 300, a computer 400, an x,y,z adjustable platform 500, a plurality of chemical dispensing control units 600, a plurality of dispensing heads and reservoirs 700, an analyser control unit 800, an analyser 900, and a data analysis station 910.

The array 100 is positioned on or under the x,y,z adjustable table or arm 500 and an image 200 is acquired and transferred to the computer 400 as a digital image. This image is either interpreted by an image analysis system 300 where the coordinates of each component of the array are transformed to values that reflect the true x, y, z axes. Alternatively, the image stored in the computer 400 is used without interpretation and the coordinates of one particular component within the array 100 are used to move the x,y,z adjustable table or arm 500 which carries a dispensing head (jetting device) 700. The dispensing head 700 is under the control of a chemical dispensing control unit 600 which is controlled by the computer 400 and dispenses a reagent or reagents, or a series of reagents onto the selected sample in the array 100. When the treatment has been completed, the coordinates of the treated component within the array 100 are used to move the x,y,z adjustable table or arm 500 which carries an analyser 900. The analyser 900 is under the control of an analysis control unit 800 which when selected by the operator via the computer 400 analyses treated selected sample 100. Data from the analysis is then collated by a data analysis and management system 910 which is correlated with the interpreted coordinates of each sample in the array from the image analysis system 300.

The x,y,z, adjustable platform, a chemical dispensing control unit, a dispensing head and reservoir, and an analyser, all under the control of a computer, are shown in FIG. 5. The array 102 is fixed onto a platform 502. The image of the array 102 is acquired via a digital camera 202. The array 102 is illuminated via a camera flash or external tungsten lamps 206. The image is transferred from the camera 202 to the computer 402. The image is processed and imported into click-on-a-spot software. This process translates the image pixel coordinates into robot coordinates. The click-on-a-spot software is then used to drive the dispensing device 702 to the selected sample in the array via an x,y movable bar 504. The z movement of the dispensing device 702 is via the dispensing device support unit 506. Reagent is dispensed from the reagent reservoir 508 via the computer control 402 of the chemical dispensing control unit 602 which is directly linked 604 to the dispensing device 702.

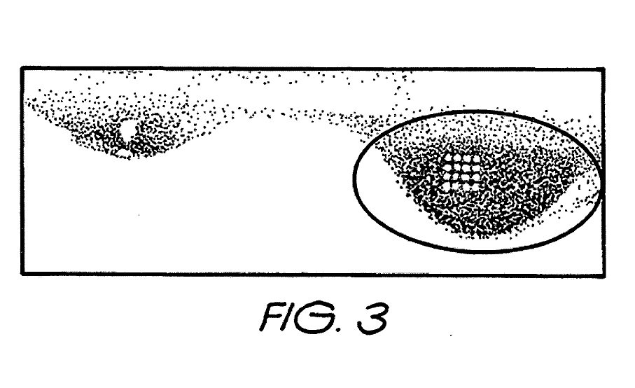

FIG. 2 illustrates the dispensing device 702 in the form of a printer head 14 moving above the protein spot (macrospot) 12 to deposit microspots of reagent onto the macrospot 12. The printer utilises piezo electric printing to leave very small quantities of liquid (of the order of picoliters) on top of the spot without contacting the spot.

The print head 14 is directed to the spots using a previously generated image of the array which provides the xy coordinates for the particular spots in the array, using the technique described in U.S. Pat. No. 6,701,254 and repeated above.

FIG. 3 shows an image of a 4×4 array of reagents deposited onto the protein spot 12 seen in FIG. 1.

Thus, in contrast with the prior art techniques, the protein chips of the present invention, which can be protein blots on membranes, provide authentic protein arrays, the ability to resolve the issues of isoforms and the technique for the removal of abundant proteins. One particular technique which is envisaged is printing patient sera onto protein arrays.

The potential uses of the present invention include the use of antibodies screening for new antigens, measuring peptide/protein interactions, and protein/protein interactions. In one application, for example, antibodies that bind to a site on a protein that can be phosphorylated, can be used to test the protein for the phosphorylated or unphosphorylated condition at a particular site.

In one aspect, the invention can be described as a method for performing an assay on an isolated macromolecule in a macrospot (spot of a macro array) on a support. The method includes determining the location of the isolated macromolecule in a macrospot on a support, adding one or more reagents in a row of microspots essentially in a line that intersects the macrospot, and detecting an interaction or reaction between the reagent or reagents and the macromolecule in the macrospot.

In another aspect, the invention is a method for performing an assay on a sample on a support, which method is carried out by separating the molecules of the sample in a gel, by a one-dimensional or two-dimensional separation method, thereby obtaining separated molecules, transferring the separated molecules from the gel to the support, thereby producing an array of molecules on the support, staining the molecules on the support, thereby rendering the separated molecules on the support detectable as macrospots, applying to the support one or more reagents in a plurality of microspots of fluid essentially in one or more parallel lines intersecting with one or more macrospots, and detecting a result of applying the reagent or reagents to the support.

In a further aspect, the invention is a method for performing an assay to characterize one or more types of macromolecule in one or more samples, the method including applying molecular weight markers and the samples to a gel for electrophoresis, separating the molecular weight markers and the macromolecules by electrophoresis, transferring the molecular weight markers and the macromolecules to a support, (e.g., a membrane), thereby producing macrospots of macromolecules, and determining the approximate location of one or more macrospots on the support, applying one or more reagents to one or more macrospots, using, for each reagent or reagents, a series of microspots essentially in a line corresponding to essentially a line parallel to the direction of migration in gel electrophoresis, and detecting results of the previous step of applying one or more reagents to the macrospot(s).

It is also an object of the invention to provide a method for carrying out a plurality of tests on at least one sample of macromolecule, wherein each sample of macromolecule is present as a macrospot in an array of macrospots on a support, in which the method is, for each test, to apply one or more reagents, in one or in sequential applications of the same or different reagent(s), to one or more macrospots, wherein the reagent(s) are applied in a series of microspots essentially in a line which intersects the macrospot(s), and to detect the results of the application of the reagents(s).

In another embodiment, the invention is a method for performing one or more tests on a plurality of samples of a macromolecule, wherein the samples have been loaded in slots and have undergone one-dimensional gel electrophoresis on a separating gel, and have been transferred from the gel to a support, the method including determining the locations of rectangles on the support corresponding to the lanes of the gel, wherein the height of the rectangle is essentially the height of the separating gel and the width of the rectangle is essentially the width of the slots; applying, for each test, one or more reagents, in one or in sequential applications of the same or different reagent(s), to the support, wherein the reagent(s) are applied essentially in microspots in a line essentially parallel to the axis along which the height of the rectangle is measured, and within a rectangle on the support corresponding to a lane of the gel; and detecting results of the application of reagent(s).

In a further variation, the invention is also a method for performing one or more tests on a plurality of samples of a macromolecule, wherein the samples have been loaded in slots of a gel and have undergone one-dimensional gel electrophoresis on a separating gel, and have been transferred from the gel to a support, said method comprising determining the locations and dimensions of rectangles on the support corresponding to lanes of the gel, wherein a first set of opposing sides of each rectangle is essentially the height of the separating gel and a second set of opposing sides of each rectangle is essentially the width of the slots; applying, for each test, one or more reagents, in one or in sequential applications of the same or different reagent(s), to the support, wherein one application produces microspots of reagent(s) in a line essentially parallel to the first set of parallel sides of a rectangle, and within the rectangle, on the support corresponding to a lane of the gel, thereby producing a line of microspots for each test; and detecting results of any reaction or interaction between the reagent(s) and the macromolecule samples.

The invention is also a method for performing one or more tests on a plurality of samples of a macromolecule, the method including loading the samples in slots of a gel and applying current for one-dimensional gel electrophoresis, transferring the samples from the gel to a support, determining the locations of rectangles on the support corresponding to the lanes of the gel, wherein the height of the rectangle is essentially the height of the gel and the width of the rectangle is essentially the width of the slots; applying, for each test, one or more reagents, by one or by sequential applications of the same or different reagent(s), to the support, wherein the reagent(s) are applied in microspots in a line essentially parallel to the axis along which the height of the rectangle is measured, and within a rectangle on the support corresponding to a lane of the gel; and detecting results of the test(s).

The invention can also be described as a method for performing one or more tests on a plurality of samples of a macromolecule, said method comprising loading the samples in slots of a gel and applying current for one-dimensional gel electrophoresis, transferring the samples from the gel to a support, determining the locations of rectangles on the support corresponding to the lanes of the gel, wherein the height of the rectangles is essentially the height of the gel and the width of the rectangles is essentially the width of the slots, applying, for each test, one or more reagents, in one or in sequential applications of the same or different reagent(s), to the support, wherein the reagent(s) are applied in microspots in a line essentially parallel to the axis along which the height of the rectangle is measured, and within a rectangle on the support corresponding to a lane of the gel, and detecting results of the application of the reagent(s).

In yet a further aspect, the invention can be described as a method for performing an assay to characterize one or more types of macromolecules of known apparent molecular weight in one or more samples, the method comprising the steps of applying molecular weight markers and the samples to a gel for electrophoresis, separating the molecular weight markers and the macromolecules by one-dimensional gel electrophoresis, transferring the molecular weight markers and the macromolecules to a support, thereby producing macrospots of macromolecules, determining the location of one or more macrospots on the support, applying a reagent, or more than one reagent in combination or sequentially, to one or more macrospots, using, for each reagent or reagents, a plurality of microspots essentially in a line essentially parallel to the direction of migration in electrophoresis, and detecting results of the application of reagent.

Depending on the purpose of the test, and depending on what is known about the target macromolecule, such as molecular weight, and how factors such as these could affect the migration of the macromolecule in the gel, the experimenter can choose to apply a line of microspots of reagent(s) of shorter or longer lengths. For example, if a potential ligand or substrate or other type of binding or reacting molecule is applied as a reagent, and the target macromolecule (e.g., a protein) is of unknown molecular weight, or there could be more than one target macromolecule to bind or react with the reagent in the macromolecule preparation loaded on the gel, the experimenter can apply reagent or reagents in one or more lines of microspots covering approximately the entire length of the support, where that length corresponds to the height of the gel, measured from the top of the gel (separating gel, as opposed to stacking gel, where a stacking gel is used at the top) to the bottom (end placed at positive anode end for electrophoresis in a gel to separate negatively charged molecules). In this method, no molecular weight markers or staining need be used to locate the appropriate coordinates for applying lines of microspots, although it would be informative to use molecular weight markers in one or more lanes of the gel to identify the molecular weight of macromolecules seen to bind to or react with reagent.

When the apparent molecular weight or an approximate molecular weight of the expected target for the reagent or reagents is known, the experimenter can run molecular weight markers in one or more lanes of the gel. The markers can be visible molecular weight markers that do not require staining. The location or locations of a macromolecule of interest can be determined from the distance the markers have migrated in the gel (distance designated as being along the y axis of the gel, where the migration starts at zero). It will be known which molecular weight markers migrate a distance greater or less than that of the macromolecule of interest in the gel, and microspots of reagent(s) can be applied to the support in what is essentially a line corresponding to the direction of gel migration. Several of these lines can be applied as essentially parallel lines within the width of a lane on the gel. The length of the line can be limited to approximately the distance between the molecular weight markers, or less. The line of reagent(s) is applied through what corresponds on the support to the expected distance of migration in the gel for the expected target, which is essentially between the y coordinates of the molecular weight markers. For example, the line of microspots can be 0.1 to 2.0 cm in length.

The method of applying a line of microspots at an approximate location on the support corresponding to the expected location on the gel where a protein should migrate, allows for the detection of isoforms of the protein. For example, the protein can be a glycosylated protein that occurs with different sugar moieties under different conditions, or is glycosylated differently in cells of different species. A reagent that reacts with or binds to all isoforms (e.g., an antibody), can be used to detect the isoforms in a sample.

The location on the support for an expected target for the reagent(s) of known apparent molecular weight can be more precisely determined, of course, when molecular weight markers are used on the gel for electrophoresis. As is well known, the distance migrated through the gel is proportional to the log of the molecular weight of the macromolecule, and the distance a macromolecule of interest has migrated through a gel can be predicted from its molecular weight, for any given gel where the distances migrated can be measured for molecular weight markers. In the case of an expensive or hard to obtain reagent, for example, it may be advantageous to limit the amount of it applied to the support to carry out an assay. Predicting a more precise location of the macromolecule on the support allows the application of a relatively short line of microspots, which can be, for example, depending on the size of the gel, 0.1-0.5 cm, 0.5-1.0 cm, or 1.0-2.0 cm in length.

The spacing between the lines of microspots 50-100 microns in diameter can be, for example, 50-100 microns apart, where the macrospots can be, for example, 200-500 microns in diameter. Lines of microspots can be typically 100 microns wide with 100 micron spacing. The number of lines of microspots to be applied to each macromolecule sample can vary according to the width of the slots used in the gel. Although regularity in the geometry of placing the microspots facilitates reading the results, and robotic instruments are readily programmed to apply uniform microspots at regular intervals in straight lines, the lines do not necessarily have to be straight, and the microspots do not necessarily have to be evenly spaced. If parallel lines of microspots are used on a macrospot, they do not necessarily have to be perfectly parallel.

Following gel electrophoresis, the arrangement of separated macromolecules is an array of macromolecules, or a macro array of macromolecules on the gel, as distinguished from a micro array consisting of an array of microspots. When the separated macromolecules are transferred to a support, the same dimensions of gel lanes and same arrangement of separated macromolecules are retained on the support, in the same macro array. The locations of the macromolecules—in macrospots or bands on the support—correspond to the locations of the macromolecules on the gel from which they were transferred, as these corresponding points were in contact during transfer of the macromolecules from gel to support. Thus, the location of the lines of microspots on the support should be within a rectangle having as its top side a line the width of the loading slot of the gel, at a location corresponding to the top of the separating gel. The sides of the rectangle correspond to the right and left sides of the gel lanes, having the length of the height of the gel, and the bottom of the rectangle corresponds to the bottom of the separating gel. Gels can be, for example, 10×10 cm, 130×80 mm, 180×180 mm or 220×220 mm, with 1-25 slots.

In one illustration (see Example 4) proteins can be isolated by the same procedure by extraction and further purification from cultures of the same cell type which have been given a different treatment or test agent (e.g., a growth factor or hormone), or grown under different culture conditions. In this case, the samples of isolated proteins corresponding to the different cell samples are loaded into uniformly spaced slots of a Laemmli gel, and the proteins of each sample are separated according to molecular weight by electrophoresis. This procedure results in a gel in which a protein of interest is found at approximately the same y coordinate across the gel, for each lane, where the lanes are known to be uniformly spaced at certain intervals along the x axis, with each lane of a known width, according to the comb used to form the wells of the polyacrylamide gel into which the protein samples were loaded. The y axis of a gel can be thought of as being parallel to the direction of the migration of the molecules in electrophoresis, and can be pictured for purposes of illustrating this method as being along the left edge of the gel. The x axis can be pictured as being along the top of the separating gel, at the interface with the stacking gel, or where no stacking gel is used, at the bottom of the loading slots produced by the comb.

Where different samples of a macromolecule of interest are found on a gel at approximately the same y coordinate in bands at regularly spaced intervals along the x axis, as can be measured from the comb used to form the gel, the regularity of the pattern of the bands of the macro array allows the location of the bands to be determined without staining the macromolecules. In cases in which the molecular weight of the protein of interest is known, the location of the band or macrospot of the protein can be determined without any staining of the gel or membrane, by using visible molecular weight markers loaded into one or more lanes of the gel (e.g., Colorburst; Sigma C4105-1VL). The protein of interest migrates in the Laemmli gel a distance along the y axis between the molecular weight marker with the closest molecular weight greater than that of the protein of interest and the molecular weight marker with the closest molecular weight less than that of the protein of interest.

Proteins and/or peptides can be stained or labeled in a gel or directly on the support (e.g., membrane) to identify candidate macrospots to be tested by methods previously described. Stains include, for example, Coomassie blue, silver stain, ninhydrin, India ink, iron stain, copper stain, colloidal gold, amido black, Direct Blue 71, and fluorescent stains, for example the SYPRO range of dyes. Labels include, for example, radiolabels, antibodies or other chemical tags. An image of the macro array can be captured and stored by instruments available for digital electrophoresis analysis, for example, the instrument described in detail herein or other instruments as described in chapter 10.5.1-10.5.14 (contributed by Scott Medberry and Sean Gallagher) in Current Protocols in Molecular Biology, with Supplements up through Supplement 52, (F. Ausubel et al., eds.), John Wiley & Sons, Inc., 1998.

Recording a digital image of the macro spots of the array on the support can be done by electronic instrument such as a scanner or digital camera. Such instruments create a record of the position of the spots and the intensity of the staining by recording pixel position and intensity. The map coordinates of each spot (detectable without staining or made detectable by a staining method following blotting) can be determined by the instrument, which allows for an investigator to select spots of a specified size, location, or staining intensity to be studied further.

A piezoelectric printer can be programmed to add reagent(s) (one reagent, mixture of reagents, or a series of additions of the same or different reagents) to selected spots of the macro array, to produce the microspots. The result of the addition of reagent can, in some cases, be observed directly, for example by a color change of a spot after addition of an enzyme, a chromophore or a fluorophore using, for example, a white light or UV scanner. In some cases, the result of the addition of the reagent can be determined directly off the macrospot by directly inserting the target into the analyzer, for e.g. a MALDI-TOF mass spectrometer.

In other cases, the instrument can be programmed to withdraw a small volume of fluid from the site or sites of the addition of reagent(s) for addition to an analyser, such as a spectophotometer or mass spectrometer. The addition of the fluid to the analytical instrument can be preceded by other steps, such as extraction, purification, or other further processing at a site some distance away from the macrospot. These steps can be performed by a mechanism that is part of the same device that adds reagent(s) to the spots of the macro array, or can be performed using a separate device.

Application of the reagent(s) to a selected location of sample can be carried out by, for example, a pipeting device or a jetting device, similar to those employed by ink-jet printers, or by other devices known in the art to deliver small volumes of fluid. In one case, a jetting device used for the purpose of applying reagents has been termed a chemical printer.

For a regular pattern of macrospots, where the spots are evenly spaced apart from each other, microspots can be applied to the macrospots on the basis of their location. For a regular pattern of macrospots, it is not necessary that the location of every macrospot be determined and recorded by a scanning device or device that employs a CCD such as a digital camera, although this method can be used. The location of all the macrospots in the array can be deduced by initially determining the position of a least two macrospots in the array, where the positions of those macrospots relative to the other macrospots in the array is known. For example, one can determine the position of the macrospots in one row (along x axis) or one column (along y axis) of a macro array of regularly spaced macrospots. In another instance, the investigator can determine the position of macrospots in one column of macrospots, wherein the macrospots are coloured or stained molecular weight markers arriving at their position from electrophoresis. The investigator can then deduce the position of other macrospots in the macro array, based on the distance the molecular weight markers have migrated through the gel, and knowing the space between the columns of macrospots (corresponding to the lanes of the gel in which the macrospot samples were separated by electrophoresis). The process of determining the positions of the macrospots can also be done by a programmable robotic instrument for carrying out the assays.

For macromolecules that are not stained on the support, molecular weight markers can be used as reference points on the membrane. A program such as ImagepIQ can be used to define the xy coordinates of known proteins and then calculate from one value (molecular weight) the related value (distance migrated in gel). The chemical printer can be programed using an array function, to print what is effectively a line from a defined starting point. To form the array, the experimenter can define the starting position (x-y coordinate 0) then the number of x points and the x mm spacing between points; and the number of y points and y mm spacing between points. In some cases, only one line of points is used. For an application such as the one in Example 4, the line can be formed by 60 microspots, 0.15 mm apart.

For a sufficient amount of protein loaded onto a gel, where the proteins of the gel are transferred to a membrane, the experimenter can stain the blot with DB71, which allows visualisation of the markers (if initially unstained markers are used, e.g., Mark 12™, Invitrogen LC5677; SDS PAGE Standards, broad range, Bio-Rad 161-0317) as well as proteins in the other lanes of the gel, defining where each lane is. The position on the membrane corresponding to each lane at the top of the separating gel can sometimes be seen on the stained membrane. An additional way to create marking points to orient the membrane blot and to determine the position of the lanes, especially where the blot is not stained, or the stain fades with blocking and washing, is to simply mark the outline of the gel and the position of the slots on the membrane when the gel and membrane are still contacted following the transfer process.

Available instruments allow an investigator to carry out a test of antibody-protein binding by the following general scheme. An image of a protein array on the membrane is captured using an embedded scanner on a chemical printing device (such as the chemical inkjet printer). The region where the microarray of microspots of antibody are to be placed is selected (“spot selection”). A print position array is designed for the region selected. The region is first blocked by printing an array of a blocking buffer (known in the art as reducing nonspecific binding to proteins). The primary antibody is then printed using the same array parameters. A wash buffer is printed. The second antibody (anti-primary antibody) is printed. A second wash is printed. The membrane with the region treated as described above is removed from the chemical printing device and developed depending on the image capture technique (chemiluminescence, fluorescence, etc.).

For an endoproteinase (e.g., trypsin) digestion of proteins in an array, the following steps can be carried out. An image of a protein array on the membrane is captured using an embedded scanner on a chemical printing device. The region where the microspots of endoproteinase are to be placed is selected (“spot selection”). A print position array is designed for the selected region. The selected region is first printed with the blocking reagent polyvinylpyrrolidone. The endoproteinase is then printed. The membrane is removed from the chemical printing device for incubation at about 37 degrees C. The membrane is placed back in the chemical printing device and matrix solution is jetted onto the spots that were digested with endoproteinase, now containing peptides. The peptides in matrix solution are removed from the chemical printing device and placed into a MALDI MS instrument. Alternatively, after the incubation step, the membrane is not returned to the chemical printing device; peptides are extracted from the spots digested with endoproteinase and placed onto a metal MALDI target plate or injected into an LC/MS instrument.

The above schemes are only examples. These schemes can, of course, be adapted for other tests of different biomolecules using different reagents and steps.

### EXAMPLE 1

The aim of this example was to develop chemical printing technology for micro-dispensing human serum that is either seronegative or seropositive for Mycobacterium tuberculosis (TB) as an approach for defining patient immunoreactivity for TB using a purified TB antigen on a nitrocellulose matrix. It will be appreciated that this approach could be used for defining patient immunoreactivity to a number of conditions or diseases by using appropriate antigens.

Materials and Methods 1.1

Human serum isolated from two patients, one seronegative and the other seropositive for TB, was diluted 1 in 10 using PBS, pH 7.4+0.05% (w/v) sodium azide +0.1% (v/v) Tween-20 (PBS wash buffer (PBS-WB)) and then filtered through a 0.22 μm syringe filter (Millipore, Danvers, Mass.). Four microlitres of a 370 μg/ml solution of purified 38 kDa TB antigen in PBS, pH 7.4 were applied onto a nitrocellulose membrane (Bio-Rad, Hercules, Calif.) and then allowed to dry. Non-specific binding sites on the nitrocellulose were then blocked for 15 min using 0.5% (w/v) casein (Sigma, St. Louis, Mo.) in PBS-WB. A 4×4 array, at 100 drops per spot, of each serum sample was then micro-jetted onto separate TB antigen spots using an AB-55 microjet device (MicroFab Technologies, Plano, Tex.), #B0-13-12 with a 55 μm orifice at a frequency of 240 Hz. The nitrocellulose was kept moist during the dispensing of serum by underlaying it with filter paper saturated with PBS-WB. Ten seconds after the serum had been jetted, the nitrocellulose was rinsed with several drops of PBS-WB using a transfer pipette. The nitrocellulose was subsequently incubated for 1 hour with anti-human IgG conjugated to FITC (Zymed, San Francisco, Calif.), at a 1 in 100 dilution in 0.5% (w/v) casein/PBS-WB, pH 7.4 followed by washing with PBS-WB. Labelled antigen was detected using a Bio-Rad FluorS™ Multi-Imager (Hercules, Calif.).

Materials and Methods 1.2

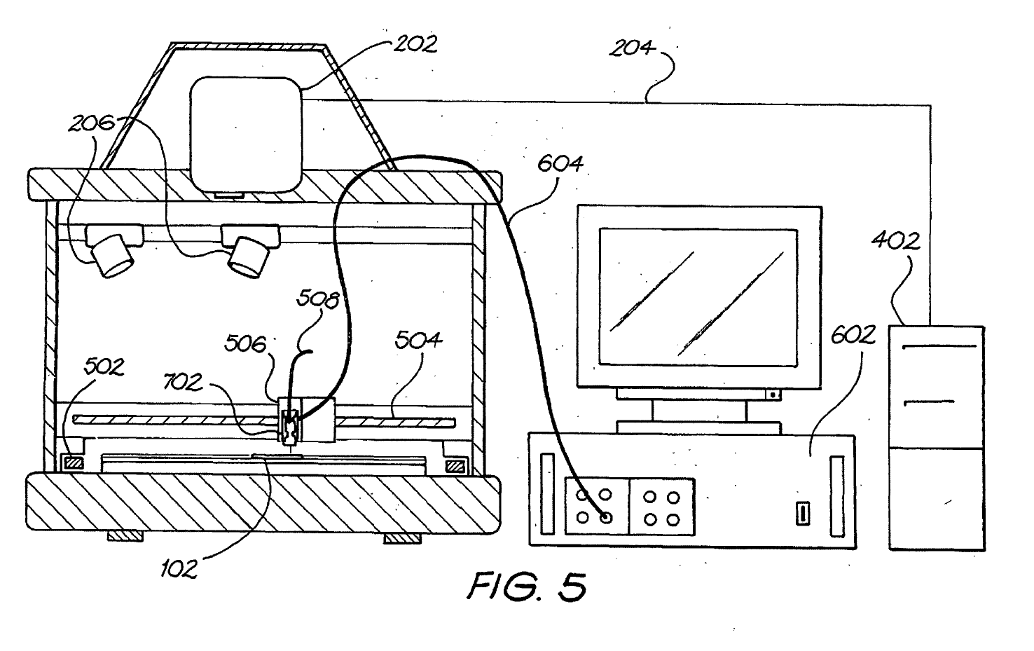

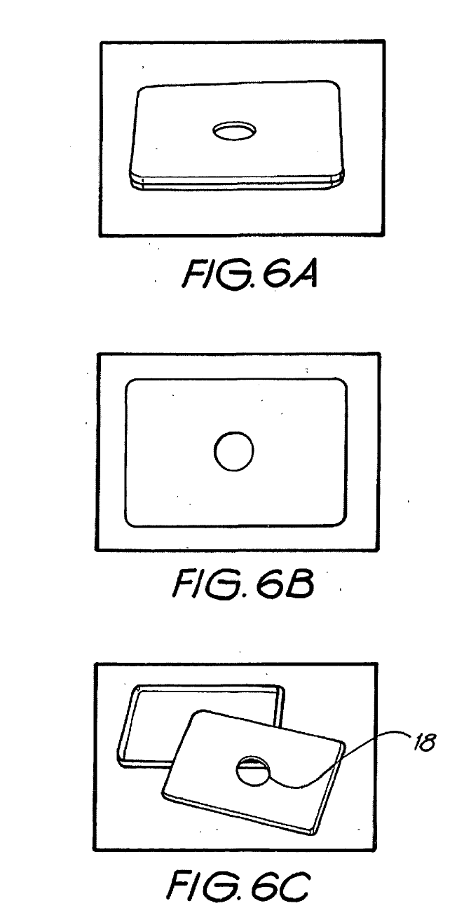

The above method was repeated except that the nitrocellulose was underlaid with absorbent tissue using the apparatus illustrated in FIGS. 6A through 6C. Absorbent tissue paper was packed beneath a nitrocellulose membrane containing TB antigen. This material was all then clamped shut inside the apparatus shown in FIGS. 6A through 6C with the area to be jetted on exposed at the circular orifice 18. The tissue paper underlay ensured that jetted solution or any applied small volume of buffer or reagent was immediately pulled through the nitrocellulose into the tissue paper allowing for an instantaneous and specific reaction. This approach prevented both non-specific drying of immunoglobulin, and hence non-specific reactions, and also prevented dispersing of specific antibody across the surface of the nitrocellulose (see below). In contrast to method 1, this device kept the nitrocellulose membrane dry during jetting. The membrane was then treated with 1 drop of PBS-WB using a transfer pipette and serum then jetted onto the antigen as described above.

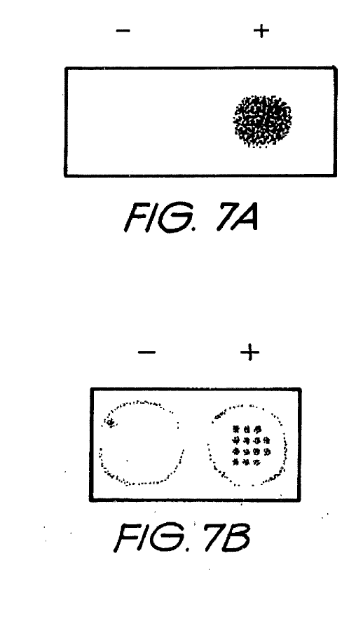

FIGS. 7A and 7B illustrate the effect of micro-jetting TB negative or positive human serum onto a 38 kDa TB antigen. A 4×4 array 20 of human serum either seronegative (−) or seropositive (+) for TB was jetted onto nitrocellulose containing 4 μl spots of 1.48 μg 38 kDa TB antigen. The nitrocellulose membranes were underlaid with either filter paper moistened with PBS-WB (A) or with tightly packed dry absorbent tissue paper (B). Labelled antigen was detected using FITC-labelled secondary antibody followed by analysis with a BIO-RAD FLUOR-S™ Multi-Imager. It is clearly evident that the tissue paper packing and dry membrane shown in FIG. 7B at 20 resulted in increased sensitivity and resolution of antigen detection.

### EXAMPLE 2

The development of chemical printing technology for micro-dispensing human serum that is either seronegative or seropositive for Mycobacterium tuberculosis (TB) as an approach for defining patient immunoreactivity for TB using a purified TB antigen subjected to SDS-PAGE and electrotransferrance to nitrocellulose with/without subsequent Direct Blue staining.

Materials and Methods 2

14.8 μg of 38 kDa TB antigen were diluted to 200 μl using ×1 SDS-PAGE non-reducing sample buffer. Sample was then analysed by SDS-PAGE (1.48 μg of antigen per lane) using a 4-12% (w/v) Tris-Bis polyacrylamide gradient gel (Invitrogen, Carlsbad, Calif.) followed by electrotransferrance to nitrocellulose. Two lanes of the blot were visualised using Direct Blue stain (FIG. 3) whilst the other two lanes were not stained. Both blots were allowed to dry at room temperature and were subsequently blocked with 0.5% (w/v) casein in PBS-WB for 15 min. Both blots were then rinsed with PBS-WB and allowed to dry. Blots were then mounted into the suction device described in FIG. 1 and seronegative or seropositive TB serum then jetted onto alternate 38 kDa bands of the Direct Blue stained blot and the non-stained blot as a 1×5 array as described above. Approximately 10 seconds later blots were washed with 2 drops of PBS-WB using a transfer pipette. Five millilitres of FITC-labelled secondary antibody diluted 1 in 10 with 0.5% (w/v) casein/PBS-WB were then applied to the blot followed 10 seconds later by two drops of PBS-WB using a transfer pipette. Labelled antigen was detected using a BIORAD FluorS™ Multi-Imager (Hercules, Calif.).

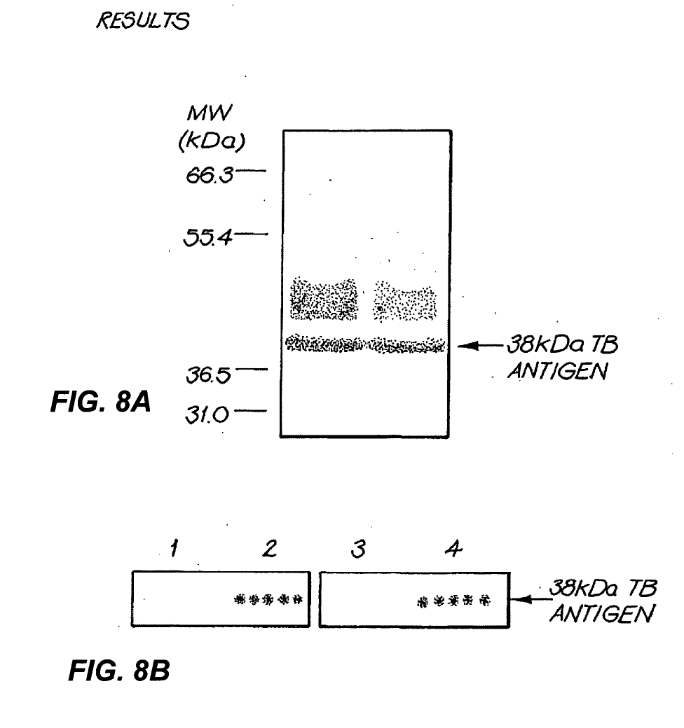

FIGS. 8A and 8B illustrate the effect of micro-jetting TB negative or positive human serum onto a denatured 38 kDa TB antigen±with or without Direct Blue Staining. (A) 38 kDa TB antigen, 1.48 μg per lane, was separated by SDS-PAGE using a 4-12% polyacrylamide gradient gel. Protein was then electrotransferred onto nitrocellulose. Two of these lanes were then stained with Direct Blue. (B) After blocking with 0.5% (w/v) casein/PBS-WB, a 1×5 array of human serum either seronegative (lanes 1 and 3) or seropositive (lanes 2 and 4) for TB was jetted (as described above) onto the 38 kDa TB antigen band. The nitrocellulose membranes were underlaid with tightly packed dry absorbent tissue paper during jetting using the apparatus shown in FIGS. 6A through 6C. Only Lanes 3 and 4 had been stained with Direct Blue prior to jetting serum (A). Labelled antigen was detected using FITC-labelled secondary antibody followed by analysis with a BIO-RAD FLUOR-STM Multi-Imager.

The current protocols using a chemical printer to dispense nanolitre volumes of human serum to a defined antigen immobilised on a nitrocellulose membrane have proven very successful and provide an extremely rapid means of detecting TB-immunoreactive IgG (less than 1 minute). No background or non-specific binding was observed. Initial studies demonstrated that dispersal of serum antibody across the surface of a moist nitrocellulose membrane after jetting created poor resolution of antibody arrays. The implementation of absorbent tissue paper beneath a dry nitrocellulose membrane has effectively overcome this problem, and now permits highly specific and well-resolved antibody arrays.

### EXAMPLE 3

This example concerns the application of enzymes to proteins on an array prior to matrix assisted laser desorption ionisation (MALDI) analysis of the fragmented protein in a mass spectrometer. As is known, different enzymes cleave proteins at different amino acid sites. Some enzymes such as LysC, AspN, ArgC cleave at only one specific amino acid site. This is a problem in MALDI analysis as it produces a few large fragments which tends not to produce a very informative spectrum. Other enzymes such as pepsin and chymotrypsin cleave proteins at many amino acid sites. Use of these enzymes prior to MALDI analysis is also problematic as too many small fragments are produced which produces a large number of very small peaks in the spectrum which are very difficult to interpret. Trypsin and GluC cleave at two amino acid sites and this tends to produce good spectra for analysis and thus are the enzymes of choice in MALDI analysis.

Even so, because these enzymes only cleave at specific amino acid sites, use of a single enzyme produces a limited amount of information or coverage on the protein. However jetting two different enzymes onto a protein spot in an array using the method of the present invention will increase the coverage of the protein. The experiment below describes the use of the method of the present invention to jet both trypsin and GluC onto two human proapolipoproteins to obtain improved coverage (matched peptides) using both GluC and trypsin compared with trypsin alone or GluC alone.

The aim of this example was to develop chemical printing technology for micro dispensing multiple endoproteases onto purified proteins subjected to SDS-PAGE and electroblotted onto polyvinyl difluoride membranes with Direct Blue staining to improve protein identification.

Materials and Methods

The sample was 36 μl of whole plasma in 7M urea, 2M thiourea, 2% (w/v) Chaps and 5 mM Tris. The sample was reduced with X tributylphosphine and alkylated with Z iodoacetamide. The sample was ultrasonicated and then centrifuged. Prefractionation of the supernatant was performed with the multicompartment electrolyzer (MCE) using methods described in Herbert, B. & Righetti, P. G., “A turning point in proteome analysis: sample prefractionation via multicompartment electrolyzers with isoelectric membranes,” Electrophoresis 21: 3639-3648 (2000), the entire contents of which are incorporated herein by reference.

Dry 11 cm 5-6 IPG strips were rehydrated for 6 hrs with 200 μl of protein sample. Rehydrated strips were focused for 120 kVhr at a maximum of 10000 V. The focused IPG strips were equilibrated for 20 mins in equilibration buffer containing 6 M urea, 2% (w/v) SDS.

The equilabrated IPG strips were inserted into the loading wells of 6-15% gel chips. Electrophoresis was performed at 50 mA per gel for 1.5 hrs. Proteins were electroblotted onto an Immobilon p^{SQ} PVDF membrane at 400 mA for 1 hr and 20 mins. Proteins were stained with Direct Blue 71.

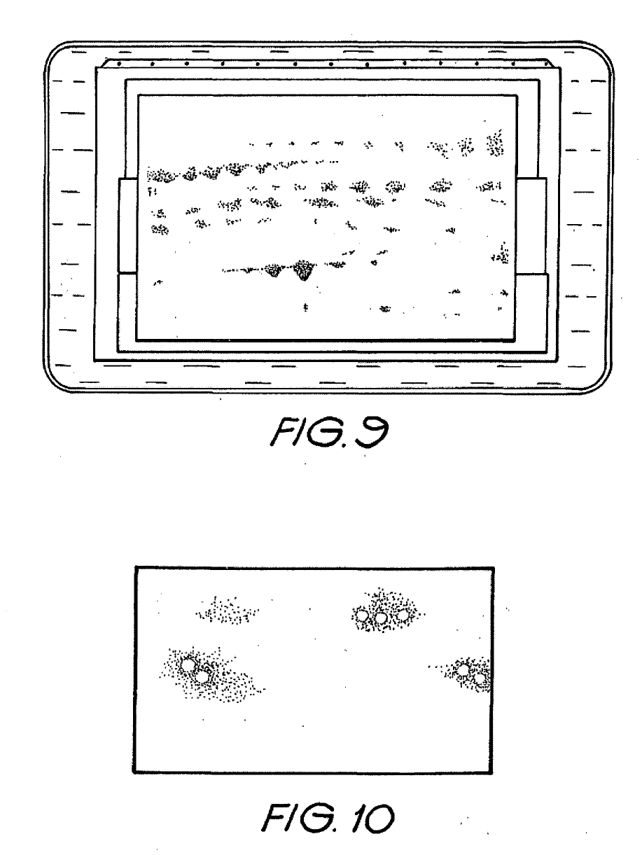

The membrane blot was then adhered to an Axima-CRF MALDI-TOF MS target plate using 3M double-sided conductive tape (refer to FIG. 9). The specified protein spots were blocked with 5 nl 1% polyvinylpyrrolidone (PVP) in 50% methanol, dispensed at 50 drops, 300 μm in diameter, onto two positions, 1 mm apart, on the one protein spot. Excess PVP was rinsed off with MilliQ™-purified water. Fifty nl of 200 μg/ml GluC endoprotease were jetted onto one of the PVP spots on the protein and X amount of 200 μg/ml of trypsin was jetted onto the remaining PVP spot on the same protein. The membrane plate was then placed in a sealed lunchbox with minimal water to create a humidified environment and incubated at 37° C. for 3 hrs. After digestion, 100 nl of 10 mg/ml of α-cyano-hydroxycinnamic acid in 20% isopropanol, 20% 2-butanol, 30% methanol and 0.5% formic acid was jetted onto the digested protein spots (FIG. 10). The digest was analyzed using the Axima CRF MALDI-TOF mass spectrometer.

The current procedure to microdispense multiple endoproteases to increase amino acid coverage for protein identification had proven successful by a combined coverage of 66.67% of matched peptides compared to 40% GluC and 46.09% trypsin coverage achievable independently.

The matrix solution used comprised 20% 2-butanol, 20% iso-propanol, 30% methanol, 30% aqua and 0.1% TFA (trifluoroacetic acid). This matrix solution has the advantage that it has a suitable viscosity to dispense stable drops over an extended period of time.

### EXAMPLE 4

The cell line RBL-2H3, derived from a rat basophilic leukemia, is a mast cell line that has been used to study receptor driven signal transduction leading to the release of inflammatory mediators. Signal transduction leads also to changes in phosphorylation of some proteins, among them the 226 kDa myosin heavy chain (MHC).

RBL-2H3 cells were grown in standard culture conditions and primed for mediator release by the addition of IgE antibody [monoclonal anti-dinitrophenyl (DNP) clone SPE-7, affinity purified mouse antibody; Sigma D8406] to the culture medium, followed by overnight incubation. The cells were washed in a standard buffer solution (NaCl, KCl, glucose, MgCl₂, PIPES). Antigen was added to activate the IgE antibody [DNP-BSA conjugate (24-36 DNP/BSA; Calbiochem-Novabiochem 324101)]. Unstimulated RBL-2H3 cells were used as controls.

The culture vessels were placed on ice. The activation medium was replaced with a small volume of ice-cold cytoskeletal lysis buffer containing KCl, MgCl₂, EGTA, ATP, Triton X-100, protease inhibitors and PIPES, and left for 15-30 minutes. The cells were scraped off the surface into microcentrifuge tubes, and centrifuged 20 minutes at 13,000 g. To the supernatant was added an equal volume of Laemmli sample buffer, and the buffered protein extract was then heated in a waterbath at boiling temperature for 5 minutes.

Samples prepared as above from stimulated and unstimulated cells were loaded into wells of an SDS-polyacrylamide gel for one-dimensional (ID) electrophoresis. Molecular weight markers (Bio-Rad broad range, 161-031) were loaded in some lanes. The proteins were separated by electrophoresis in the gel. The proteins were transferred onto PVDF membrane by blotting. The proteins in the blot were stained with Direct Blue 71 (Sigma Aldrich 21,240-7) and the blot was transferred to a chemical inkjet printer (CHIP; Shimadzu Biotech).

Using concentrations determined to be optimal, antibodies were printed as 0.5 to 1 cm long lines (rows of microspots spaced 0.15 mm apart) parallel to the y axis of the blot, over the region of the blot, the width of a gel lane, where the MRC band was visible by staining. Each microspot was the result of a number of applications of 50 pL of fluid in succession, for a total of 1-4 nL per microspot, with 3 parallel lines of antibodies deposited on each band or macrospot of MHC. The antibodies were:
anti-phospho-threonine [Cell Signaling Technology (9381)];
anti-nonmuscle myosin [Biomedical Technologies Inc. (BT-561)]; and
anti-phospho-serine/threonine [Cell Signaling Technology (9611)].

The printed area of the membrane was then washed with buffer using the ChIP, to remove unbound antibodies. A secondary antibody, an affinity-isolated sheep anti-rabbit IgG antibody conjugated with horse radish peroxidase (HRP) [Chemicon Australia; AP3222P] was printed over the same line of microspots as the primary antibody. The excess unbound secondary antibody and non-specifically bound antibody were also removed using the ChIP by extensive washing of the printed area of the membrane with buffer. Specific binding was detected by the addition of a chemiluminescent substrate to react with the secondary antibody [SuperSignal West Femto Maximum sensitivity substrate (34096, Pierce, Rockford, Ill.)]. The chemiluminescent product was detected by placing the membrane between plastic sheets and placing the layers in a light tight cassette with X-ray film for a period of several seconds to minutes.

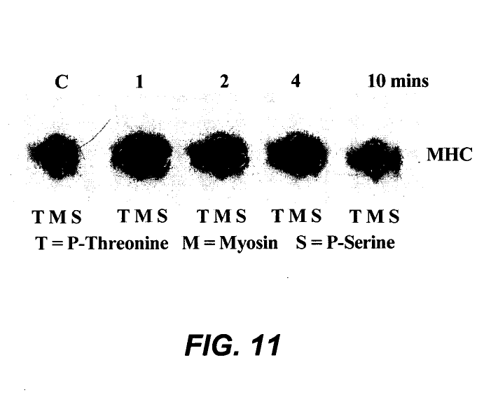

Three antibodies were printed onto 5 bands of MHC samples that resulted from a timecourse sampling of mast cells after activation of the cells by antigen. Sampling times were 1, 2, 4 and 10 minutes following activation. The MHC was found in the cytoskeletal supernatant fraction after extraction in a standard Triton-based buffer. The antibodies printed over each MHC band were, in order from left to right in FIG. 11, anti-phosphothreonine, anti-nonmuscle myosin, and anti-phosphoserine. The anti-myosin antibody acts as a positive control, showing that there is a similar level of myosin in each sample. The result demonstrates that in the unstimulated or control cells (C), there is little or no phosphorylation of the MHC, but that by 1 minute after activation, there is an increase in the proportion of MHC that is phosphorylated. The increase in phosphorylation is observed on both threonine and serine residues (see FIG. 11). As the timecourse of activation progresses, there is a waning of MIC phosphorylation, and by 10 mins the proportion of MHC that is phosphorylated has returned to near control levels.

This example demonstrates that at least three separate levels of information may be obtained from one band, at one time. The method illustrated herein allows for the comparison of antibody binding to one sample of protein, where, using previously described methods, three different western blots would be used to observe similar results. In other experiments, four different antibodies have been tested on one band on a membrane.

While this invention has been particularly shown and described with references to preferred embodiments thereof, it will be understood by those skilled in the art that various changes in form and details may be made therein without departing from the scope of the invention encompassed by the appended claims.

1. A method for performing one or more tests on a plurality of samples of a macromolecule, wherein the samples have been loaded in slots of a gel and have undergone one-dimensional gel electrophoresis on a separating gel, and are on a support, said method comprising:
a) determining the locations and dimensions of rectangles on the support corresponding to lanes of the gel, wherein a first set of opposing sides of each rectangle is essentially the height of the separating gel and a second set of opposing sides of each rectangle is essentially the width of the slots;
b) applying, for each test, one or more reagents, in one or in sequential applications of the same or different reagent(s), to the support, wherein one application produces microspots of reagent(s) in a line essentially parallel to the first set of parallel sides of a rectangle, and within the rectangle, on the support corresponding to a lane of the gel, thereby producing a line of microspots for each test; and
c) detecting one or more results of step b).

2. The method of claim 1 wherein the support is a membrane.

3. The method of claim 1 wherein the line extends for a length which is essentially the entire height of the separating gel.

4. The method of claim 1 wherein the line is 0.1-2.0 cm long.

5. The method of claim 1 wherein more than one line of microspots is produced within each of one or more rectangles on the support corresponding to the lanes of the gel.

6. The method of claim 1 wherein the line extends essentially between the y coordinates of two macromolecules used as markers in the one-dimensional gel electrophoresis.

7. A method for performing one or more tests on a plurality of samples of a macromolecule, said method comprising:
a) loading the samples in slots of a gel and applying current for one-dimensional gel electrophoresis;
b) transferring the samples from the gel to a support;
c) determining the locations of rectangles on the support corresponding to the lanes of the gel, wherein the height of the rectangles is essentially the height of the gel and the width of the rectangles is essentially the width of the slots;
d) applying, for each test, one or more reagents, in one or in sequential applications of the same or different reagent(s), to the support, wherein the reagent(s) are applied in microspots in a line essentially parallel to the axis along which the height of the rectangle is measured, and within a rectangle on the support corresponding to a lane of the gel; and
e) detecting one or more results of step d).

8. The method of claim 7 wherein the samples are proteins prepared from cell cultures or tissue samples.

9. The method of claim 7 wherein one or more reagents are antibodies.

10. The method of claim 7 wherein more than one test is performed within a rectangle on the support corresponding to a lane of the gel.

11. The method of claim 7 wherein in step e) detecting results is by detecting a fluorescent product.

12. The method of claim 7 wherein in step e) detecting results is by detecting a coloured product.

13. A method for performing an assay to characterize one or more types of macromolecule in one or more samples, said method comprising:
a) applying the samples to a gel for electrophoresis;
b) separating the macromolecules by one-dimensional gel electrophoresis;
c) transferring the macromolecules to a support, thereby producing macrospots of macromolecules;
d) determining the location of one or more macrospots on the support;
e) applying one or more reagents to one or more macrospots, using, for each reagent or reagents, a series of microspots essentially in a line essentially parallel to the direction of migration in electrophoresis; and
f) detecting one or more results of step e).

14. The method of claim 13 wherein step d) is by defining at least the x coordinates of the lines on the support, which lines are essentially parallel to the y-axis, said lines corresponding to the boundaries of the lanes of the gel, where the x-axis on the support corresponds to the top of the separating gel.

15. The method of claim 13 wherein at least one type of macromolecule is a phosphorylated protein, and at least one reagent is an antibody specific to a phosphorylated site on the phosphorylated protein.

16. The method of claim 13 wherein at least one type of macromolecule is a glycosylated protein, and at least one reagent is an antibody that binds to the glycosylated protein.

17. A method for performing an assay to characterize one or more types of macromolecules of known molecular weight in one or more samples, said method comprising:
a) applying molecular weight markers and the samples to a gel for electrophoresis;
b) separating the molecular weight markers and the macromolecules by one-dimensional gel electrophoresis;
c) transferring the molecular weight markers and the macromolecules to a support, thereby producing macrospots of macromolecules;
d) determining the location of one or more macrospots on the support;
e) applying a reagent, or more than one reagent in combination or sequentially, to one or more macrospots, using, for each reagent or reagents, a plurality of microspots essentially in a line essentially parallel to the direction of migration in electrophoresis; and
f) detecting one or more results of step e).

18. The method of claim 17 wherein the macromolecules are proteins.

19. The method of claim 17 wherein step f) is by defining the x coordinates of the lines on the support, which lines are parallel to the y-axis, said lines corresponding to the boundaries of the lanes on the gel, where the x-axis on the support corresponds to the top of the separating gel, and by finding the y coordinates of the molecular weight markers and determining the y coordinate of the macromolecule from distance migrated=log (molecular weight).

20. The method of claim 17 wherein step f) is by mass spectrometry.

21. The method of claim 17 wherein a chemiluminescent product is detected in step f).
